(19) United States
(12) Patent Application Publication
(10) Pub. No.: US 2011/0286897 A1
(43) Pub. Date: Nov. 24, 2011

(54) Microtiter plate

(75) Inventors: Thomas Uschkureit, Henstedt-Ulzburg (DE); Christian Ziegmann, Ahrensburg (DE); Hanna Rethwisch, Hamburg (DE); Carsten Koch, Grossenbrode (DE); Matthias Haak, Oldenburg (DE); Martin Seippel, Ammersbek (DE); Rainer Juergen Schulz, Seeretz (DE)

(73) Assignee: EPPENDORF AG, Hamburg (DE)

(21) Appl. No.: 13/017,545

(22) Filed: Jan. 31, 2011

Related U.S. Application Data
(60) Provisional application No. 61/301,729, filed on Feb. 5, 2010.

(51) Int. Cl. B01L 3/00; B29C 45/00

(52) U.S. Cl. 422/553; 264/239

(57) ABSTRACT

Microtiter plate made of plastic, having a plurality of wells in a plate which has at least one break line that divides the plate into various segments. The break line includes a joint line which is formed by molding together various segments of the plate.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a microtiter plate having a plurality of wells in a plate which has at least one break line that divides the plate into various segments.

Microtiter plates are used for various microbiological, molecular biological, cellular biological, and immunological procedures. Microtiter plates are used in particular for PCR or the culturing of microorganisms or cells.

On the recommendation of the Society of Biomolecular Screening (SBS), ANSI has published standards for microtiter plates which concern in particular the dimensions and positions of the wells for microtiter plates having 96, 384, and 1536 wells. These involve ANSI/SBS Standards 1-2004 through 4-2004, as well as Standard SBS-5 currently under development, the entire contents of which are incorporated herein by reference.

Microtiter plates are used on a somewhat limited basis in many laboratories. This is due in particular to the fact that the reagents used are expensive, and the fewest possible reactions are carried out. Common applications, including qualitative PCR, often require only up to 24 reactions maximum. As a result, for a microtiter plate having 96 wells only part of the wells are used, and the microtiter plate is discarded with a portion of the wells unused.

A microtiter plate is known from U.S. Pat. No. 5,084,246, the entire contents of which is incorporated herein by reference, which has a frame-like base and a plurality of vessel strips. The vessel strips are removable from the base, and the individual vessels of each strip are separable. The vessels in each vessel strip are joined by connecting elements having a T-shaped cross section which hold the vessels in a flat linear array when the vessel strips are either held in, or removed from, the base. The T-shaped connecting elements are readily severable to permit easy separation of individual vessels. This design is complicated. In addition, the design is also space-consuming when only a few vessel strips are occupied, since the base cannot be adapted to the number of required vessels.

Microtiter plates having 96 wells and provided with a side skirt are marketed by Corning under the trade name “Thermowell® 96-well polypropylene PCR microplate.” The wells are situated in vessels which project beyond the underside of the plate and slightly over the top side of the plate. The skirt similarly projects beyond the underside and the top side of the plate. The plate, vessels, and skirt are produced in one piece from polypropylene. Located at the top side of the plate and in the part of the skirt projecting upward from the plate, after the third, sixth, and ninth row of wells in each case, is a notch which is used for placing a cutting tool in order to divide the plate. Breaking off individual segments is impracticable for this microtiter plate.

A microtiter plate for PCR is known from U.S. Pat. No. 6,558,631 B1, the entire contents of which is incorporated herein by reference, comprising a plurality of wells which are held together in a matrix array by a plate. The plate is divided into segments of predetermined size by one or more slots which extend essentially over the width of the plate. The slots extend through the entire wall of the plate, with adjacent segments being joined together by one or more connecting regions associated with each of the slots. The connecting regions are formed by essentially circular regions which extend over the slots, the circular regions having weakened areas at their circumference to facilitate separation from the plate. The system of slots and connecting regions is suitable for simplifying the subdivision of the microtiter plate into segments of predetermined size, which then pass into a thermocycler without hindering one another. The plate may be broken by bending at the slots. Alternatively, the plate may be cut up using scissors, a knife, a scalpel, or some other cutting tool. Material residues remaining on the connecting regions must be removed using a cutting tool.

Such microtiter plates for PCR are made of polypropylene, since polypropylene is neutral with respect to DNA and has sufficient temperature resistance.

The known PCR plate may be separated only after bending adjacent segments back and forth about the break line several times and tearing apart the segments. For this reason, the user preferably uses scissors or another cutting tool for assistance. In addition, after the separation, sharp tearing edges remain which may cause injury to the user or cut into the user's gloves or tear same, resulting in a contamination risk for the sample and/or user.

### BRIEF SUMMARY OF THE INVENTION

On this basis, the object of the invention is to provide a microtiter plate which simplifies targeted separation into various segments and which does not inadvertently break during use or transport.

The object is achieved using a microtiter plate having the features of Claim 1.

The plastic microtiter plate according to the invention has a plurality of wells in a plate which has at least one break line that divides the plate into various segments, the break line including a joint line which is formed by molding together various segments of the plate.

For the microtiter plate according to the invention, good break behavior is achieved by the fact that the break line includes a joint line. The joint line is produced by molding together the various segments of the plate in the injection molding process. When the adjacent segments of the plate are injection-molded at the same time, separate plasticized plastic compounds are introduced in each case into the cavities of the mold which are associated with the various segments. The flow fronts of the plasticized plastic compounds meet one another, and form a joint line at that location. When a microtiter plate having a reduced cross section at the break line is injection-molded, the injection mold has a decreased gap in the region of the break line. The flow fronts are retarded in the gap, and therefore meet one another very uniformly and at a defined location. The break line may be defined solely by the joint line. The strength of the plate is reduced at the joint line, thus allowing it to be easily broken along the break line.

The plate may be produced using the co-injection process, with simultaneous extrusion of the various segments. Various segments of the plate may also be extruded in succession using the transfer technique, the rotation or displacement technique, or the core-back technique. First, at least one segment is extruded, and in a further injection molding step at least one additional segment is molded onto the molded part thus produced. During the molding, the flow front of the plasticized plastic compound meets the edge of the already solidified plastic compound and fuses onto same. This likewise results in a weakened joint line, which facilitates a clean break of the plate.

The various segments may be extruded from the same plastic. In addition, they may be extruded from the same plastic, with the material of the various segments having the same color or different colors. The various segments may also be extruded from different plastics. The break behavior may be advantageously influenced by using different plastics for the various segments of the plate.

The plastic microtiter plate according to the invention has a plurality of wells in a plate which has at least one break line that divides the plate into various segments, the plate being made of an amorphous plastic or from a fiber-reinforced, partially crystalline plastic.

The polypropylene used for conventional PCR plates has a relatively tough characteristic. Namely, it has relatively low rigidity and therefore a relatively low modulus of elasticity (E-modulus) and a relatively high elongation at break, so that it is basically unbreakable. This also applies for other partially crystalline materials. On the other hand, according to the invention amorphous materials are used which instead are basically vitreous and highly transparent. Amorphous materials have a relatively high E-modulus and a relatively low elongation at break. For this reason amorphous materials are relatively rigid, so that they are difficult to bend. They also have a tendency to break in a sudden, uncontrolled manner. Therefore, as such they do not appear to be suitable for producing a microtiter plate which is to be separated into defined segments in a targeted manner. Surprisingly, however, it has been shown that a plate made of an amorphous plastic may be easily broken along a break line at which the plate has a reduced wall thickness and/or has one or more holes and/or a joint line. This may also be achieved using a plate made of fiber-reinforced, partially crystalline plastic. Namely, the fiber-reinforced, partially crystalline plastic has a higher E-modulus and a lower elongation at break compared to the partially crystalline plastic. In combination with the break line, this likewise results in good break behavior.

The plastic microtiter plate according to the invention has a plurality of wells in a plate which has at least one break line that divides the plate into various segments, the break line including a groove at the underside of the plate.

For the microtiter plate according to the invention, good break behavior is achieved due to the break line having the groove at the underside of the plate. When a segment is bent upward about the break line, the plate breaks at the groove as a result of the notch effect, without having to bend the plate back and forth numerous times. This results in a clean break. In addition, situating the groove at the underside facilitates the provision of the wells in vessels which project from the underside of the plate. When the microtiter plate is broken part, the vessels adjacent to the break line are swiveled away from one another, and do not interfere with the breaking of the plate. In addition, this configuration prevents the vessels adjacent to the break line from being damaged during breakage of the plate as the result of mutually directed forces.

According to one embodiment, the groove widens, at least in places, toward the underside of the plate. This is advantageous for manufacturing, since it facilitates demolding of the injection-molded part. According to one preferred embodiment, the groove is V-shaped, U-shaped, or trapezoidal. The groove is particularly preferably V-shaped since, as a result of the converging sloped walls, a line is defined on which the forces are concentrated during the breakage, and along which the break occurs.

In all the invention variants, the good break behavior is characterized in that after targeted bending, preferably once, about the break line to a degree which greatly exceeds bending due to customary stresses in handling and transport, the plate breaks along the break line, wherein sharp break edges are avoided or occur only to a slight degree. The bending angle which results in the break is preferably at least 5°, and may be as high as 180°. The bending angle which results in the break is preferably at least 10°, more preferably at least 15°. Thus, the microtiter plate does not break apart inadvertently during handling and transport, and may be easily broken into segments in a targeted manner. A key advantage in use is that the segments which are broken apart do not have sharp edges. On the one hand, this greatly reduces the direct risk of injury when the plates are broken apart, and on the other hand the risk of the user's gloves being torn into or cut is reduced. All the invention variants result in a more haptically satisfactory break behavior, and facilitate a smooth, supple break surface. These advantageous characteristics are particularly pronounced for combinations of the invention variants.

According to one embodiment, the break line includes at least one groove in the underside and/or in the top side of the plate, and/or at least one hole in the plate. The break line may have a single groove or multiple grooves situated one behind the other. The hole may be slot-shaped or circular. The break line may have a single hole which preferably is slot-shaped, or may have a series of holes which may be slot-shaped or circular. The groove or the hole has a notch effect which promotes good break behavior. The groove is preferably V-shaped.

According to one preferred embodiment, the plate has a wall thickness of 1 to 3 mm next to the groove, and/or has a wall thickness of 0.1 to 1 mm in the groove. In addition, the plate preferably has a wall thickness of 1.5 to 2.5 mm next to the groove, and/or has a wall thickness of 0.2 to 0.4 mm in the groove. Furthermore, the plate preferably has a wall thickness of 0.25 to 0.35 mm, preferably approximately 0.3 mm, in the groove.

According to one embodiment, the break line extends parallel to the narrow sides and/or the longitudinal sides of the plate. The break line preferably extends only parallel to the narrow sides, or only parallel to the longitudinal sides, of the plate. This has the advantage that segments may be separated from the microtiter plate which may be filled using customary multichannel pipettes. Namely, in the design of the multichannel pipettes having eight channels, the columns of the wells which are parallel to the narrow sides may be filled, and in the design of the multichannel pipettes having 12 channels, the rows of the wells which are parallel to the longitudinal sides may be filled.

According to another embodiment, the break lines terminate in edges of the plate and/or in recesses in the edges of the plate. Breakage of the plate into various segments is simplified in this way.

According to one preferred embodiment, the plate is made of a plastic having an E-modulus of at least 1500 N/mm². According to another embodiment, the plate is made of a plastic having an E-modulus of at least 2000 N/mm².

According to one embodiment, the plate is made of polycarbonate (PC), cyclo-olefin copolymer (COC), cyclo-olefin polymer (COP), polystyrene (PS), or polymethylmethacrylate (PMMA), or of fiber-reinforced polypropylene (PP) or polyethylene (PE) or some other polyolefin.

According to one preferred embodiment, the plate is made of polycarbonate having an elongation at break of 100 to 120% maximum.

According to another embodiment, the plate is made of a partially crystalline plastic reinforced with long glass fibers. In a partially crystalline plastic reinforced with long glass fibers, the fibers lie parallel to the joint line when the various segments are molded onto one another, so that no reinforcement occurs in the joint line. As a result, the material fails in the joint line at the interface between the fiber-reinforced region and the adjacent fiber-free zone. In contrast, reinforcement of a partially crystalline plastic with short glass fibers results in increased rigidity of the plate. However, the short glass fibers also reinforce the plate beyond the joint line, so that the plate may be broken only under deformation which is greater than for reinforcement of the partially crystalline material with long glass fibers.

The wells may have various shapes. According to one embodiment, the wells are pot-shaped (cylindrical) and/or cup-shaped (spherical shell-shaped, for example) and/or conical (cone-shaped). The wells may also have different shapes in different sections, for example cylindrical in an upper region and conical therebelow, and cup-shaped at the lower end.

According to another embodiment, the microtiter plate has differently shaped wells in various positions, and/or has differently shaped wells or only wells having the same shape in various segments. Thus, the variation in the shape of the wells may refer to wells at different positions on the same microtiter plate, to wells in different segments of the microtiter plate, or to different microtiter plates. A microtiter plate in which all of the wells have only one consistent shape is preferred.

The invention further relates to possible embodiments in which the surface of the microtiter plate varies. For example, edges of the wells may project beyond the plate to differing degrees. These differing degrees may refer to individual positions on the same microtiter plate, to different segments on the same microtiter plate, or to different microtiter plates. However, a microtiter plate in which the surface is uniformly pronounced over all segments is preferred.

According to another embodiment, the microtiter plate has 96 wells or a multiple of 96 wells (for example, 384 or 1536 wells). According to another embodiment, the microtiter plate meets one or more of the above-referenced ANSI/SBS standards.

According to another embodiment, the microtiter plate has one, two, or three break lines, so that it may be broken into two, three, or four segments. The resulting segments are easily handled. However, the microtiter plate may also be provided with even more break lines. The microtiter plate may be provided with break lines in particular between all adjacent columns of wells or between all adjacent rows of wells, so that strips, each including a column or a row of adjacently situated wells, may be separated. However, break lines may also be present between all adjacent columns and all adjacent rows, so that segments having any desired number of wells may be separated. In particular, segments which include only a single well may be separated.

The wells may be provided in a solid plate. According to one preferred embodiment, the wells are situated in vessels which are connected to the plate. This favors wells which have a relatively large volume. In addition, by suitably selecting the materials of the plate and of the vessels it may be ensured that on the one hand the plate has the necessary stability and is breakable, and on the other hand, sample liquid which is filled into the wells comes into contact with a suitable plastic. In particular, this allows microtiter plates for PCR to be designed in such a way that the plate is relatively rigid, and the vessels are made of a plastic which is suitable for the PCR. However, in principle the plate and the vessels may also be made of the same material, with the vessels and the plate having the same or different colors.

In principle, the vessels may be designed in such a way that they do not project beyond the underside or the top side of the plate. According to one preferred embodiment, the vessels project from the underside and/or the top side of the plate. This favors vessels which have a relatively large filling volume. In addition, microtiter plates in which the vessels project from the underside of the plate are particularly vessel suited for use in thermocyclers for PCR, since the heat exchange can take place directly between the plate of the thermocycler and the walls of the vessels. When the vessels project beyond the top side of the plate, this is advantageous for the sealing attachment of a cover film directly to the upper edges of the vessels.

According to one preferred embodiment, the plate and the vessels are joined together in one piece. The plate and the vessels may be joined together in one piece in particular by injection molding. According to one embodiment, the plate has a plurality of holes, and the vessels are joined to the plate in one piece by molding onto the edges of the holes.

According to one embodiment, the plate is made of a first plastic, and the vessels are made of a second plastic which is different from the first plastic. According to another embodiment, the plate and vessels are made of the same plastic.

EP 1 161 994 B2, the entire contents of which is incorporated herein by reference, describes a microtiter plate in which the vessels are joined to the plate in one piece by molding onto the edges of the holes, and the vessels and the plate are made of different plastics. In this microtiter plate the plate is made of a relatively rigid plastic. PC, for example, may be used as plastic for the plate; PP, for example, may be used as plastic for the vessels for use in PCR; and silicone, for example, may be used for supplying samples with oxygen. This microtiter plate may be designed to be very dimensionally accurate and stable, and having very thin-walled vessels for good heat transfer or for supplying samples with oxygen.

EP 1 346 772 A2, the entire contents of which is incorporated herein by reference, describes a microtiter plate in which the plate has a plurality of holes and has vessels made of the same plastic as the plate, which are joined to the plate in one piece by molding onto the edges of the holes. This microtiter plate has the advantage of high dimensional accuracy and stability. The plate and the vessels may be made of PP, for example. Plastics of the plate and of the vessels may have the same color or different colors.

The plate according to the invention may be designed or manufactured corresponding to the plate according to EP 1 161 994 B2/US 2001051112 A1, the entire contents of which is incorporated herein by reference, or EP 1 346 772 A2/US 2003 180 192 A1, the entire contents of which is incorporated herein by reference. The statements in this regard in the above-cited publications are incorporated by reference into the present patent application.

In principle, however, the vessels may also be joined to the plate by clipping, screwing, adhesive bonding, welding, sealing, or by detachably or undetachably connecting in some other way.

According to another embodiment, the plate has segments which are made of a different plastic and/or which have different colors.

Providing different shapes of the wells and/or surfaces of the microtiter plate and/or colors of the segments and/or the vessels offers the possibility of identifying/labeling samples. For various steps of a diagnostic procedure, for example, this allows the use of optically clear or transparent vessels for the preparation of samples, white vessels for real-time PCR, and black, optically opaque vessels for light-protected storage.

The invention further relates to a method for manufacturing a microtiter plate from plastic, having a plurality of wells in a plate which has at least one break line that divides the plate into various segments, the various segments of the plate being molded to one another along the break line.

According to one embodiment, the method is a co-injection method, a transfer method, a rotation or displacement method, or a core-back method.

The invention is explained in greater detail below with reference to the accompanying drawings of one exemplary embodiment, showing the following:

### BRIEF DESCRIPTION OF THE SEVERAL VIEWS OF THE DRAWINGS

FIGS. 1a through f show a microtiter plate having 96 wells, in an oblique perspective view from above and from the side (FIG. 1a), in an oblique perspective view from below and from the side (FIG. 1b), in an enlarged oblique detail view from below and from the side (FIG. 1c), in an enlarged vertical section through two adjacent vessels (FIG. 1d), in an enlarged top view of the edge region and two adjacent vessels (FIG. 1e), and during breaking off of a segment, in an oblique perspective view from above and from the side (FIG. 1f);

FIG. 2 shows another microtiter plate having break lines having interrupted slots, in the top view; and

FIGS. 3a through c show another microtiter plate having differently shaped wells in an oblique perspective view from below and from the side (FIG. 3a), in a longitudinal section along line A-A from FIG. 3c (FIG. 3b), and in a top view (FIG. 3c).

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

In the present patent application, the terms “above” and “below” refer to an orientation of the microtiter plate in which the wells are configured with the openings on top and with their closed end on the bottom.

In the following description of various exemplary embodiments, corresponding elements have the same reference numerals. The description of the corresponding elements applies to all exemplary embodiments having these elements.

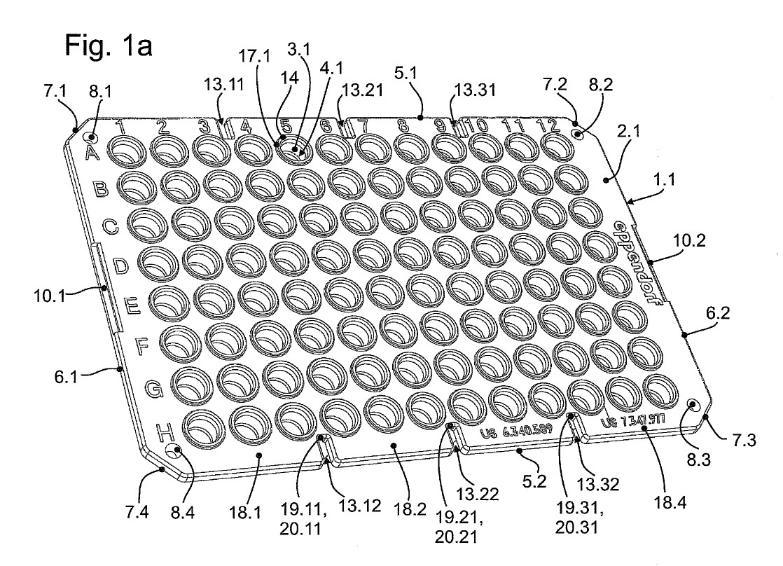

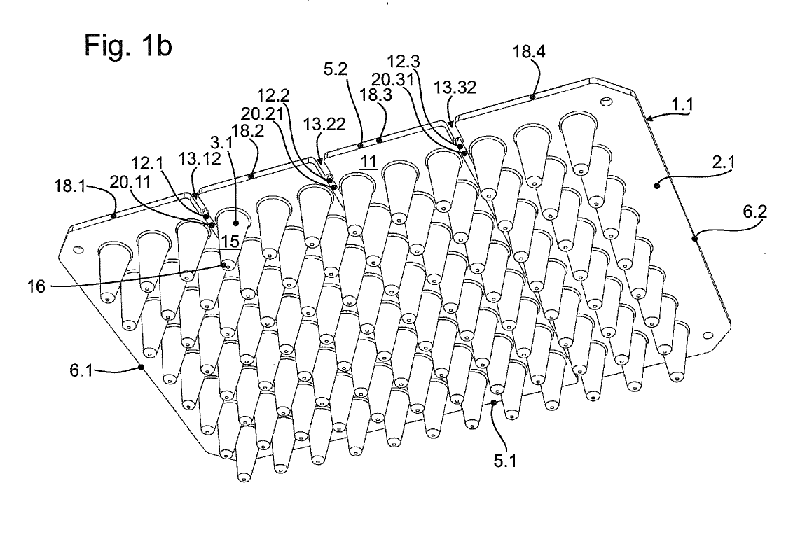

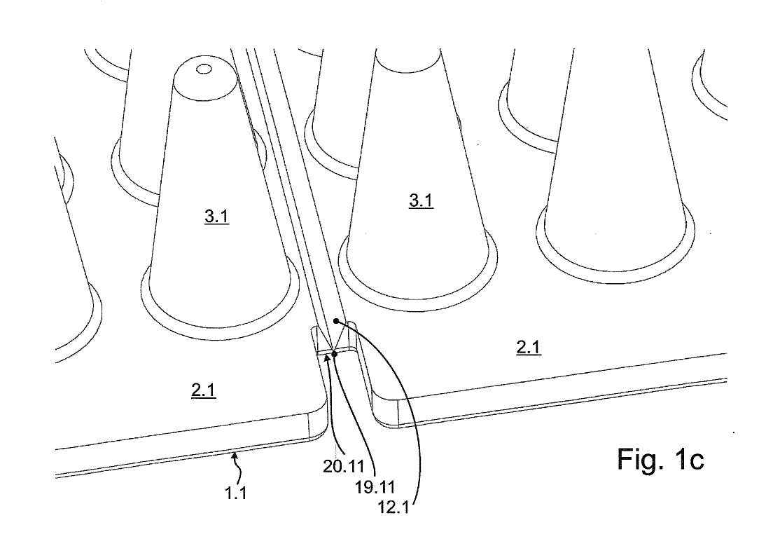

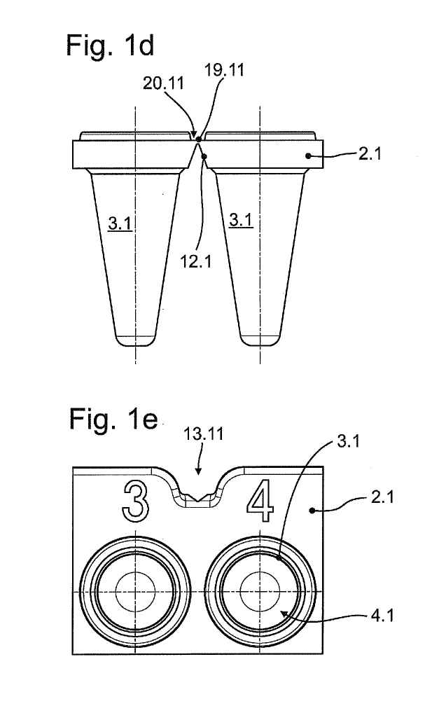

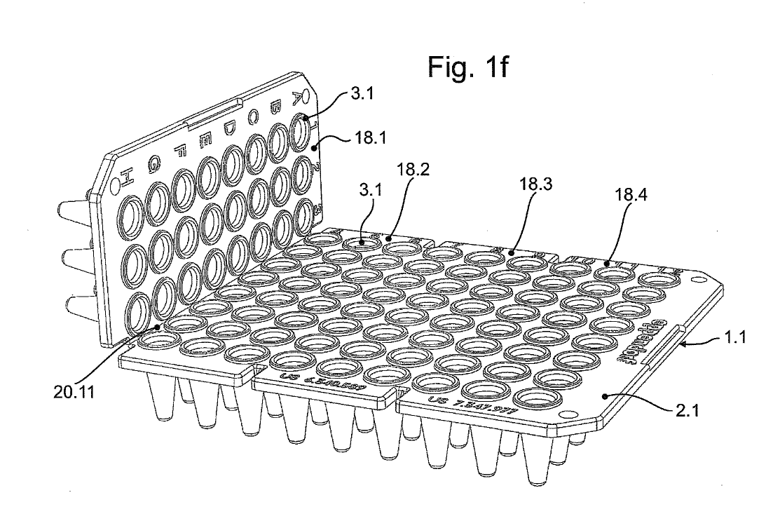

According to FIG. 1, a microtiter plate 1.1 comprises a plate 2.1 and a plurality of vessels 3.1. A total of 96 vessels 3.1 are arrayed in eight columns and 12 rows in the manner of a matrix. Wells 4.1 are provided in the vessels 3.1.

The plate 2.1 is essentially rectangular, with two parallel longitudinal sides 5.1, 5.2 and two parallel narrow sides 6.1, 6.2. The corners between adjacent longitudinal sides 5 and narrow sides 6 may have bevels 7.1 through 7.4. Centering holes 8.1 through 8.4 are provided next to the corners of the plate 2.1.

Next to the longitudinal side 5.1 the plate 2.1 has printed, lasered, or embossed numbers 1 through 12 on the top side 9 which designate the columns of the vessels 3.1. Next to the narrow side 6.1 the plate 2.1 has printed, lasered, or embossed letters A through H on the top side 9 which designate the rows of the vessels 3.1.

Steps 10.1, 10.2 may be situated in the upper edges of the narrow sides.

The plate 2.1 has a V-shaped groove 12.1, 12.2, 12.3 in the underside 11 between the third and fourth column, the sixth and seventh column, and the ninth and tenth column, respectively. The V-shaped grooves 12.1, 12.2, 12.3 have a cross section which widens toward the underside 11 of the plate 2.1. The wall thickness of the plate 2.1 next to the grooves 12.1, 12.2, 12.3 is 1 mm to 3 mm, preferably approximately 2 mm. In the grooves 12.1, 12.2, 12.3 the remaining wall thickness of the plate is 0.2 mm to 0.4 mm, preferably approximately 0.3 mm.

The grooves 12.1, 12.2, 12.3 terminate in slot-shaped recesses 13.11, 13.12, 13.21, 13.22, 13.31, 13.32 which extend in the direction of the grooves 12.1, 12.2, 12.3, from the longitudinal sides 5.1, 5.2 of the plate 2.1 to the outer rows A and H of the vessels 3.1.

The vessels 3.1 are molded onto the edges of the holes 4. The vessels have a circular ring-shaped upper edge 14 which projects slightly beyond the top side 9 of the plate 2.1, and a conical section 15 which projects beyond the underside 11 of the plate 2.1, as well as a cup-shaped section 16 at the lower end. At the top side 9 of the plate 2.1 and at the underside 11 of the plate 2.1 the vessels 3.1 have a respective protrusion 17.1, 17.2, i.e., radial projection, which supports the vessels at the top side 9 and at the underside 11 of the plate 2.1.

The plate 2.1 is injection-molded from polycarbonate, for example. The vessels 3.1 are injection-molded from polypropylene or a silicone, for example. The microtiter plate 1.1 is preferably manufactured in the multicomponent injection molding process. The microtiter plate may in particular have the features of the plate and the vessels according to EP 1 161 994 B2, the entire contents of which is incorporated herein by reference, or US 2001051112 A1, the entire contents of which is incorporated herein by reference, and may be manufactured according to the method described in the above-cited publications. The statements in this regard in the referenced publications are incorporated by reference into the present patent application. Alternatively, the microtiter plate 1.1 may have the features of the plate and the vessels according to EP 1 346 772 A2, the entire contents of which is incorporated herein by reference, or US 2003180192 A1, the entire contents of which is incorporated herein by reference, and may be manufactured according to the method described therein. The statements in this regard in the referenced publications are incorporated by reference into the present patent application.

In the manufacture of the microtiter plate 1.1, the segments 18.1, 18.2, 18.3, 18.4 of the plate 2.1 which are separated from one another by the V grooves 12.1, 12.2, 12.3 are also individually extruded. This results in joint lines 19.11, 19.21, 19.31 at the base of the grooves 12.1, 12.2, 12.3, at which the melt fronts of the plasticized materials, which form the various segments 18.1, 18.2, 18.3, 18.4 of the plate 2.1, meet. The joint lines 19.11, 19.21, 19.31 together with the V grooves 12.1, 12.2, 12.3 form break lines 20.11, 20.21, 20.31.

On account of the joint lines 19.1, 19.2, 19.3, the use of polycarbonate for the plate 2.1, and the notch effect due to the V grooves 12.1, 12.2, 12.3, the upward bending of individual segments 18.1, 18.2, 18.3, 18.4 results in a haptically satisfactory break behavior and a smooth, supple break surface. The break occurs when a segment 18.1 of the plate 2.1 corresponding to FIG. 1f is bent upward by approximately 90° with respect to the remainder 18.2, 18.3, 18.4 of the plate 2.1.

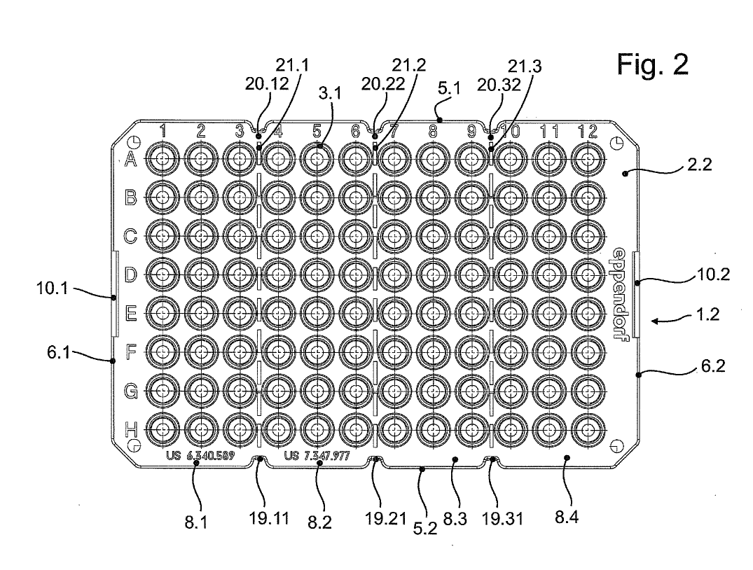

The plate 1.2 according to FIG. 2 differs from the previously described plate in that the break lines 20.12, 20.22, 20.32 have a series of rectangular slots 21.1, 21.2, 21.3, respectively, instead of the V grooves 12.1, 12.2, 12.3. The break lines 20.12, 20.22, 20.32 also include a joint line 19.12, 19.22, 19.32, respectively. The joint line 19.12, 19.22, 19.32 in combination with the plastic used for the plate 2.2, and the notch effect due to the slots 21.1, 22.2, 21.3, likewise results in a haptically satisfactory break behavior and a smooth, supple break surface when individual segments 18.1 according to FIG. 1f are folded upward with respect to the remainder 18.2, 18.3, 18.4 of the plate 2.2.

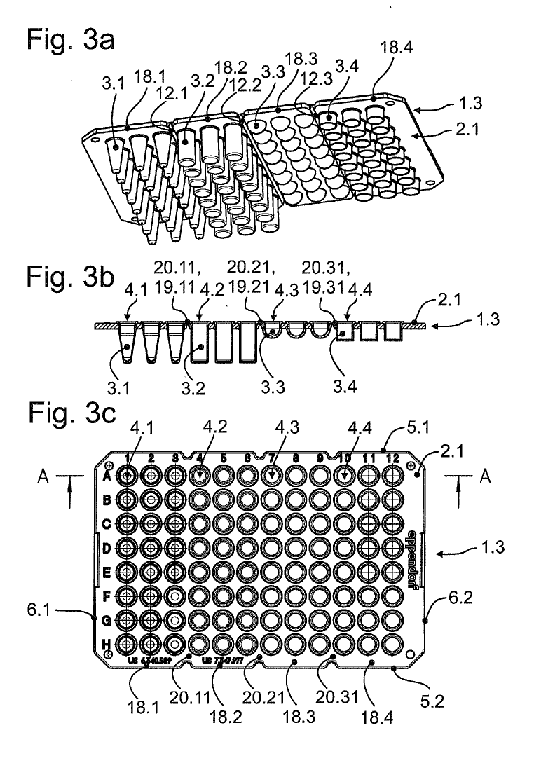

The microtiter plate 1.3 of FIG. 3 differs from the microtiter plate 1.1 in that vessels 3.1, 3.2, 3.3, 3.4 having different shapes and having corresponding wells 4.1, 4.2, 4.3, 4.4 are provided in the various segments, the shape of the wells 4.1, 4.2, 4.3, 4.4 in the respective segment 18.1, 18.2, 18.3, 18.4 being uniform in each case. The left segment 18.1 has vessels 3.1 whose shape corresponds to the shape of vessels 3.1 of microtiter plate 1.1. In the adjacent segment 18.2 the vessels 3.2 have a circular cylindrical shape. In the next segment 18.3 the vessels 3.3 have a cup shape. In the right segment 18.4 the vessels 3.4 once again have a cylindrical shape, these cylinders having a lower height than those for the vessels of segment 18.2. In the example, the height of these vessels 3.4 is only approximately one-third the height of vessels 3.2.

The vessels 3.1, 3.2, 3.3, 3.4 having various shapes may be used for different tests in which vessels having different volumes with different vessel shapes are useful.

Due to the break lines 20.11, 20.21, 20.31, the microtiter plate 1.3 may also be separated into segments in the same way as for the microtiter plate 1.1.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. Microtiter plate made of plastic, having a plurality of wells (4) in a plate (2) which has at least one break line (20) that divides the plate (2) into various segments (18), characterized in that the break line (20) includes a joint line (19) which is formed by molding together various segments (18) of the plate (2).

2. Microtiter plate made of plastic, having a plurality of wells (4) in a plate (2) which has at least one break line (20) that divides the plate (2) into various segments (18), characterized in that the plate is made of an amorphous plastic or from a fiber-reinforced, partially crystalline plastic.

3. Microtiter plate made of plastic, having a plurality of wells (4) in a plate (2) which has at least one break line (20) that divides the plate (2) into various segments (18), characterized in that the break line includes a groove (12) in the underside (11) of the plate (2).

4. (canceled)

5. Microtiter plate according to claim 1, characterized in that the break line (20) includes at least one groove (12) in the underside (11) and/or in the top side (9) of the plate (2), and/or at least one hole (21) in the plate (2).

6. Microtiter plate according to claim 3, characterized in that the plate (2) has a wall thickness of 1 to 3 mm next to the groove (12), and/or has a wall thickness of 0.1 to 1 mm in the groove (12).

7. Microtiter plate according to claim 3, characterized in that the groove (12) widens, at least in places, toward the underside (11) of the plate (2).

8. Microtiter plate according to claim 3, characterized in that the groove (12) is V-shaped.

9. Microtiter plate according to claim 1, characterized in that the break line (20) extends parallel to the narrow sides (6) and/or longitudinal sides (5) of the plate (2).

10. Microtiter plate according to claim 1, characterized in that the break lines (20) terminate in the edges of the plate (2) and/or in recesses (13) in the edges of the plate (2).

11. Microtiter plate according to claim 1, characterized in that the plate (2) is made of a plastic having an E-modulus of at least 1500 N/mm2.

12. Microtiter plate according to claim 11, characterized in that the plate (2) is made of a plastic having an E-modulus of at least 2000 N/mm2.

13. Microtiter plate according to claim 1, characterized in that the plate (2) is made of polycarbonate, cyclo-olefin copolymer, cyclo-olefin polymer (COP), polystyrene, or polymethylmethacrylate, or of fiber-reinforced polypropylene or polyethylene or some other polyolefin.

14. Microtiter plate according to claim 1, characterized in that the plate (2) is made of a partially crystalline plastic reinforced with long glass fibers.

15. Microtiter plate according to claim 1, characterized in that said microtiter plate has pot-shaped and/or cup-shaped and/or conical wells (4).

16. Microtiter plate according to claim 15, characterized in that said microtiter plate has differently shaped wells (4) in various positions, and/or has differently shaped wells (4) or only wells (4) having the same shape in various segments (18).

17. Microtiter plate according to claim 1, characterized in that the plate (2) has segments (18) which are made of different plastics and/or which have different colors.

18. Microtiter plate according to claim 1, characterized in that said microtiter plate has 96 wells (4) or a multiple of 96 wells (4).

19. Microtiter plate according to claim 1, characterized in that said microtiter plate has one, two, or three break lines (20).

20. Microtiter plate according to claim 1, characterized in that the wells (4) are situated in vessels (3) which are connected to the plate (2).

21. Microtiter plate according to claim 20, characterized in that the vessels (3) project from the underside (11) and/or the top side (9) of the plate (2).

22. Microtiter plate according to claim 20, characterized in that the plate (2) and vessels (3) are made of the same plastic or from different plastics.

23. Microtiter plate according to claim 20, characterized in that the plate (2) and the vessels (3) are joined together in one piece.

24. Microtiter plate according to claim 20, characterized in that the plate (2) has a plurality of holes, and the vessels (3) are joined to the plate (2) in one piece by molding onto the edges of the holes.

25. Method for manufacturing a microtiter plate from plastic, having a plurality of wells (4) in a plate (2) which has at least one break line (20) that divides the plate (2) into various segments (18), characterized in that the various segments (18) of the plate (2) are molded to one another along the break line (30).
